(19) United States
(12) Patent Application Publication
(10) Pub. No.: US 2003/0024567 A1
(43) Pub. Date: Feb. 6, 2003

(54) Water drain valve for fluid tank on locomotive

(76) Inventors: Andrew R. Spriegel, Willoughby Hills, OH (US); James R. Palumbo, Cuyhoga Falls, OH (US); Todd C. Cronin, Solon, OH (US)

Correspondence Address: Keith J. Murphy, Cantor Colburn LLP, 55 Griffin Road South, Bloomfield, CT, 06002, US

(21) Appl. No.: 09/919,529

(22) Filed: Jul. 31, 2001

(51) Int. Cl. F16K 31/64

(52) U.S. Cl. 137/62

(57) ABSTRACT

A drain valve for a cooling system of a locomotive engine includes an orifice disposed in fluid communication with the cooling system of the engine, a flow restricting element communicable with the orifice, and an actuator mechanism disposed in mechanical communication with the flow restricting element. The actuator mechanism is fabricated of a shape memory metal.

### BACKGROUND

Locomotive engine coolant systems, in contrast to those of truck and automotive applications, utilize circulating water without antifreeze to remove heat from the engines during operation. Thus, in a typical locomotive cooling system, the water is subject to freezing when the locomotive is non-operational and subject to low temperatures. In order to guard against the freezing of the water, a drain valve is incorporated into the cooling system at a low point thereof to allow the water to be drained from the system in the event that the temperature approaches freezing.

The drain valve is generally configured to be electro-mechanically or mechanically actuated. In the electromechanical configuration, the water temperature and the battery voltage are sampled with the relevant instrumentation and analyzed by a control algorithm. The resultant value determined by the control algorithm is compared with a value in a lookup table. Comparison of the resultant value and the value from the lookup table then determines whether the drain valve is actuated. In particular, if the temperature of the water deviates from a preselected operating parameter (as determined from the lookup table) and/or the battery voltage drops to a selected value, then the drain valve is electronically opened and the water is drained from the coolant system.

Another method of actuating the drain valve includes the mechanical manipulation of the valve. In such a method, sampling of relevant conditions of the system is performed manually. A determination of whether the water is drained is then based on an operator comparison of the operating parameters with values in a lookup table. If the comparison of values warrants the draining of the water from the coolant system, the drain valve is manually opened to allow the water to drain from the system.

### SUMMARY

A drain valve for a cooling system of a locomotive engine is disclosed herein. The valve includes an orifice disposed in fluid communication with the cooling system of the engine, a flow restricting element communicable with the orifice, and an actuator mechanism disposed in mechanical communication with the flow restricting element. The actuator mechanism is fabricated of a shape memory metal.

### BRIEF DESCRIPTION OF THE DRAWINGS

FIG. 1 is a sectional view of a water drain valve having a shape memory metal actuator mechanism.

FIG. 2 is a perspective cutaway view of a valve enclosure having a water drain valve with a shape memory metal actuator mechanism.

FIG. 3 is a side elevation view of a diesel engine, a lube oil cooler in fluid communication with the diesel engine, and an engine cooling system incorporating a water drain valve having a shape memory metal actuator mechanism.

FIG. 4 is a sectional view of a water drain valve having two shape memory metal actuator mechanisms.

FIGS. 5 and 6 are sectional views of a water drain valve actuatable with a spring and having a shape memory metal latching mechanism.

FIGS. 7 and 8 are plan views of a shape memory metal latching mechanism for a water drain valve.

FIG. 9 is a perspective view of a shape memory metal latching mechanism having a tubular geometry.

### DETAILED DESCRIPTION

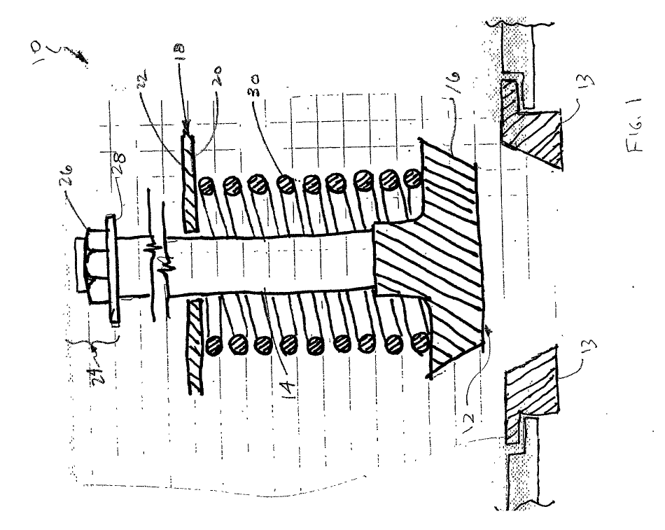

Referring to FIG. 1, an exemplary embodiment of a water drain valve is shown generally at 10 and is hereinafter referred to as “valve 10.” Valve 10 serves to regulate the flow of cooling water (or some other coolant) through the cooling system of a locomotive engine in such a manner so as to allow for the drainage of the water from the system.

Valve 10 is shown in a globe valve configuration and comprises a flow restricting element such as a plug or a disk, shown generally at 12 and hereinafter referred to as “disk 12,” disposed on a stem 14. Disk 12 is biased by an actuator mechanism (described below) in the direction of an orifice that defines the flow path of the cooling water of the system. Instead of a globe valve, valve 10 may be configured as a gate valve, a plug cock valve, a ball valve, a butterfly valve, or any other type of valve.

Disk 12 is received in a seat 13 disposed in the orifice, thereby regulating the flow of the water through the orifice. Complete closure or “seating” of disk 12 in seat 13 effectively prevents the passage of the water from a stem side of disk 12 to an opposing side of disk 12. Opening of the orifice by removal of disk 12 from seat 13 enables the flow of water through the orifice to be regulated to varying degrees. Although disk 12 is illustrated as having a chamfered outer edge 16, it should be understood by one of ordinary skill in the art that outer edge 16 may be otherwise dimensioned, e.g., rounded to mate with a correspondingly configured seat.

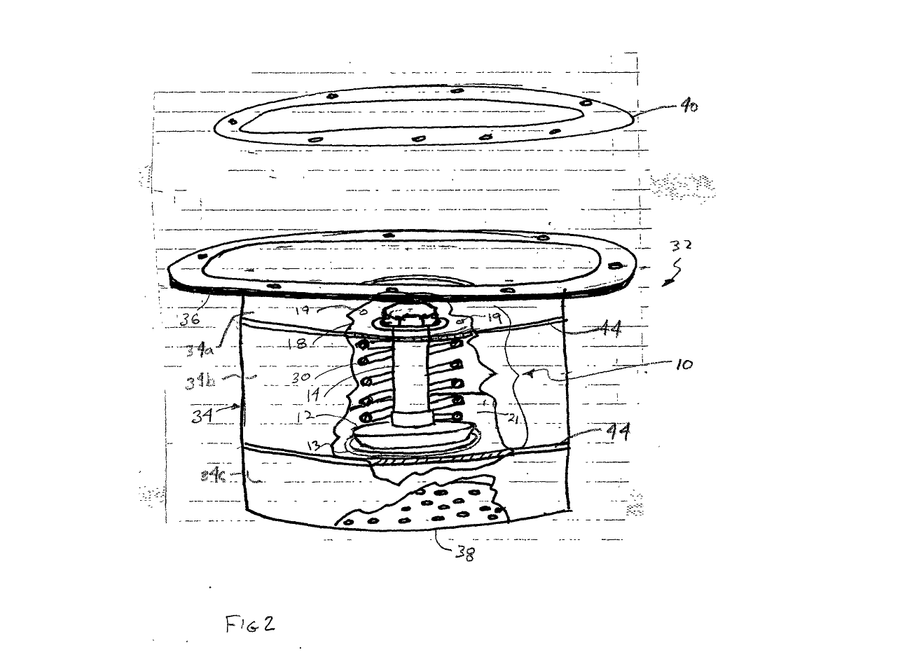

Stem 14 slidably extends through an aperture in a support member, shown generally at 18. Support member 18 is fixedly mounted within a shell (shown below with reference to FIG. 2) such that a planar face 20 of support member 18 is adjacent to the end of stem 14 on which disk 12 is disposed while an opposing planar face 22 is adjacent to an opposing end of stem 14 distal from disk 12. The opposing end of stem 14 is configured to receive a stopper device, shown generally at 24. As shown, stopper device 24 is threadedly received on stem 14 and includes a nut 26 and plate member 28, which may be a washer, disposed intermediate nut 26 and support member 18. Stopper device 24 effectively prevents stem 14 from extending through the aperture in support member 18.

Stem 14 is axially translatable through the aperture in support member 18 in response to the dynamic characteristics of the actuator mechanism, which is fabricated from a “shape memory metal.” A shape memory metal is a thermoelastic material that is dimensionally deformable upon an application or removal of heat and exhibits an ability to “remember” its pre-deformed shape and to substantially return to such shape upon a corresponding removal or application of heat. Although the actuator mechanism may be any shape or configuration including, but not being limited to, any type of spring, a torsion bar, or a wire, the actuator mechanism is shown as a coil spring and is hereinafter referred to as “spring 30.” Spring 30 is defined by a helically arranged coil and is disposed between planar face 20 of support member 18 and the stem side of disk 12 such that stem 14 extends through spring 30 along a longitudinal axis thereof. Regardless of its configuration, spring 30 is fixedly connected to planar face 20 of support member 18 and the surface of the stem side of disk 12. The expansion and contraction of spring 30 causes the sliding axial translation of disk 12 and stem 14 into or out of seat 13.

The shape memory metal of which spring 30 is fabricated is an alloy that exhibits an ability to transform its crystalline structure in response to changes in temperature. One particular alloy that can be used for the fabrication of spring 30 is nickel titanium. The composition of the nickel titanium alloy for use in spring 30 is chosen such that the transformation in its crystalline structure occurs at about 40° F. Depending upon the manufacturing process used to “train” the alloy to transform its crystalline structure, shape memory metals can exhibit either two-way memory (in which the crystalline structure can change and subsequently revert back to its original structure) or one-way memory (in which the crystalline structure can change and retain its new crystalline structure). In one-way memory, the amount of recoverable strain is about 6% to about 8% while in two-way memory, the amount of recoverable strain is only about 2%.

The training process to instill two-way memory into a nickel titanium alloy generally involves overdeformation of the alloy while in the martensitic phase, temperature cycling, load cycling, constrained aging processing, or a combination of any of the foregoing. If trained to exhibit two-way memory, at high temperatures the nickel titanium alloy exists in the austenitic phase. Upon cooling, however, the crystalline structure of the alloy transforms back to the martensitic phase. Upon an application of heat, the crystalline structure of the nickel titanium alloy reverts to the austenitic phase and recovers its previous shape. By transforming its crystalline structure in accordance with its phase changes, the nickel titanium alloy exhibits changes in dimensions. Depending on the configuration of the metal, such changes in dimensions can produce substantial changes in a particular direction and thus be utilized to effectively drive an element (e.g., disk 12).

When spring 30 is fabricated of the nickel titanium alloy configured as a helically arranged coil, transformations between the austenitic and martensitic phases effect transformations in the crystalline structure that directly correspond to substantial changes in spring 30 in an axial direction. Less substantial changes in spring 30 are also produced in a direction radial to the longitudinal axis of spring 30. The actuation of valve 10 is effectuated by the substantial changes in the axial direction. In particular, at the higher temperatures characteristic of the operation of the locomotive engine into which valve 10 is incorporated, spring 30 extends in the direction along its longitudinal axis to drive disk 12 into seat 13, thereby preventing the flow of water through the orifice (and preventing drainage of the cooling system of the locomotive engine). However, as the temperature of the water in the cooling system decreases, the nickel titanium alloy of spring 30 transforms back to the martensitic phase changing the crystalline structure of the alloy such that spring 30 contracts and removes disk 12 from seat 13, thereby allowing water to flow through the orifice.

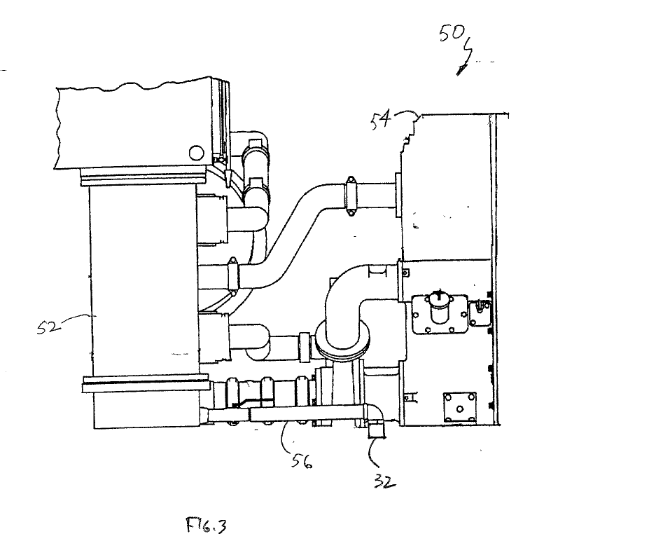

In FIG. 2, the valve is illustrated as it would be mounted in a valve enclosure unit, shown generally at 32 and hereinafter referred to as “enclosure 32.”Enclosure 32 comprises a shell of tubular geometry, shown generally at 34, having a flange 36 disposed at one end and a screen 38 disposed at an opposing end. Flange 36 is mountable to a drain pipe (shown below with reference to FIG. 3) on the locomotive engine to enable the cooling water to be drained through valve 10. A gasket 40 is disposed between flange 36 and the drain pipe.

Cylindrical shell 34 comprises at least one shell segment, three of which are shown at 34a, 34b, and 34c. Any number of shell segments may be assembled to form cylindrical shell 34, each shell segment being connected to another by either a direct coupling method, such as welding or brazing, or through the use of coupling devices (not shown) disposed at an interface 44 defined by adjacently positioned shell segments. One particular type of coupling device that can be used is a VICTAULIC coupling device. Such devices are commercially available from Victaulic Company located in Easton, Pa., and require no specific disclosure. In the event that valve 10 requires disassembly for replacement of spring 30, VICTAULIC coupling devices provide fast and efficient breakdown and reassembly of enclosure.

As shown, support member 18 is mounted between shell segments 34a and 34b and is configured to allow stem 14 to be slidably received therethrough. Support member 18 is further configured to allow the water to pass through by, for example, the locating of holes 19 in support member 18 that provide fluid communication from one side of support member 18 to the other. A seat support member 21 is mounted between shell segments 34b and 34c and includes the orifice, which is positioned to be in register with disk 12 and stem 14. Seat 13 is positioned peripherally about the orifice. Screen 38 is disposed across the end of cylindrical shell 34, thereby providing a barrier that prevents the introduction of foreign objects into enclosure 32.

Fluid communication is maintained between the drain pipe and spring 30 of valve 10 through holes 19 during the operational phase of the locomotive engine. Depending upon the temperatures of the water and the engine, heat may be transferred between the water and spring 30. At the normal operating temperatures of the engine, the crystalline structure of the alloy from which spring 30 is fabricated is such that spring 30 remains in its originally formed position. Upon the temperature of the water (and spring 30) dropping below a preselected value determined by the alloy composition, the crystalline structure of the alloy is altered and spring 30 retracts to unseat disk 12 from seat 13, thereby allowing the water to flow through the orifice.

Referring to FIG. 3, an engine cooling system incorporating the valve is shown generally at 50. Engine cooling system 50 comprises a cooling apparatus 52 maintained in fluid communication with an engine 54. Cooling apparatus 52 provides for heat exchange between the oil of engine 54 and the water of engine cooling system 58. The water is drained from cooling apparatus 52 through drain pipe 56. The valve, which is mounted in enclosure 32, is installed into engine cooling system 50 in drain pipe 56 to effectively cause the automatic drainage of the water in the event that the temperature approaches the freezing point of water. Although enclosure 32 is shown as being mounted at the end of drain pipe 56, it should be understood that enclosure 32 may be mounted at any point in drain pipe 56. By incorporating the valve actuatable by the shape memory metal to provide for the drainage of engine cooling system 50, the sampling and analyzing of the cooling water as well as the comparison of a calculated result with a value in a lookup table is avoided.

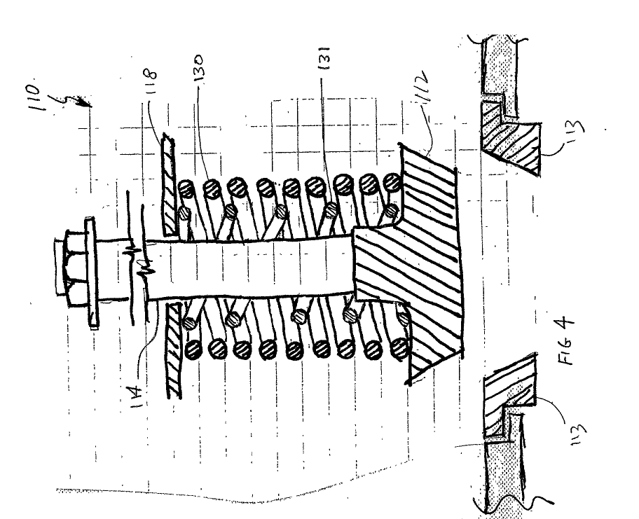

Referring now to FIG. 4, another exemplary embodiment of a water drain valve is shown generally at 110 and is hereinafter referred to as “valve 110.” Although valve 110 is shown as a globe valve, valve 110 may be configured as a gate valve, a plug cock, a ball valve, a butterfly valve, or any other type of valve. Valve 110 comprises a disk 112 disposed on one end of a stem 114, a spring 130 disposed on stem 114, and a return spring 131 disposed on stem 114 and positioned within spring 130. Although return spring 131 is depicted as being positioned within spring 130, it should be understood that spring 130 may be positioned within return spring 131.

Disk 112 is configured to be received in a seat 113 disposed in an orifice that defines the flow path of a fluid (not shown), thereby regulating the flow of the fluid through the orifice. One end of stem 114 is supported at one side of disk 112 and extends substantially normally therefrom. An opposing end of stem 114 is supported by springs 130, 131 to slidably extend through a support member 118. Spring 130 is configured in a coil fashion and is disposed between a stem side of disk 112 and support member 118 such that stem 114 extends longitudinally through the coils of spring 130. Spring 130 is fixed at both support member 118 and disk 112. Return spring 131 is configured in a coil fashion and is dimensioned to be positionable within spring 130. Return spring 131 is likewise fixed at both support member 118 and disk 112.

In valve 110, springs 130, 131, like spring 30 of FIG. 1, are fabricated from nickel titanium alloys. The alloys in this embodiment, however, exhibit only one-way memory. In one-way memory, the changes in dimension of the alloy are heat- or cold-induced deformations that are not recoverable by the converse application of a cooling or heating effect. Recovery of a shape similar to that which the component held prior to the temperature induced phase change can be obtained by mechanical deformation of the component. The alloys of which each spring 130, 131 is fabricated are such that the phase transformation temperature of one is different than the phase transformation temperature of the other prior to a mechanical deformation of the one by the other. For purposes of this embodiment, the phase transformation temperatures of the alloys used for each spring 130, 131 are about 40° F. The temperature differential between the phase transformation temperatures of each spring 130, 131 is about ten Fahrenheit degrees.

Spring 130 is dimensioned such that upon assembly of valve 110, disk 112 is not received in seat 113, thereby allowing for the flow of water through the orifice. The alloy of which spring 130 is constructed is “trained” with one-way memory such that as the temperature increases over about 40° F. the alloy transforms from the martensitic phase to the austenitic phase and causes the closing of valve 110. Return spring 131, which is dimensioned to facilitate its mounting within spring 130, is mechanically deformed (stretched) upon the extension of spring 130 to close valve 110. The alloy of which return spring 131 is constructed is trained with one-way memory such that as the alloy then cools from a temperature over about 40° F. to a temperature of just under about 40° F., the alloy of which return spring 131 is fabricated “remembers” its previous unstretched shape and reverts to that shape, thereby causing spring 130 to compress and pull disk 112 from seat 113 to open valve 110. Upon a subsequent increase in temperature caused by cooling water greater than about 40° F. coming into contact with springs 130, 131, spring 130 then “remembers” its pre-compressed shape and extends, re-stretching return spring 131 in the process, to re-seat disk 112 in seat 113. In valve 110, the one-way configuration of springs 130, 131 provide long term stability for millions of heating and cooling cycles.

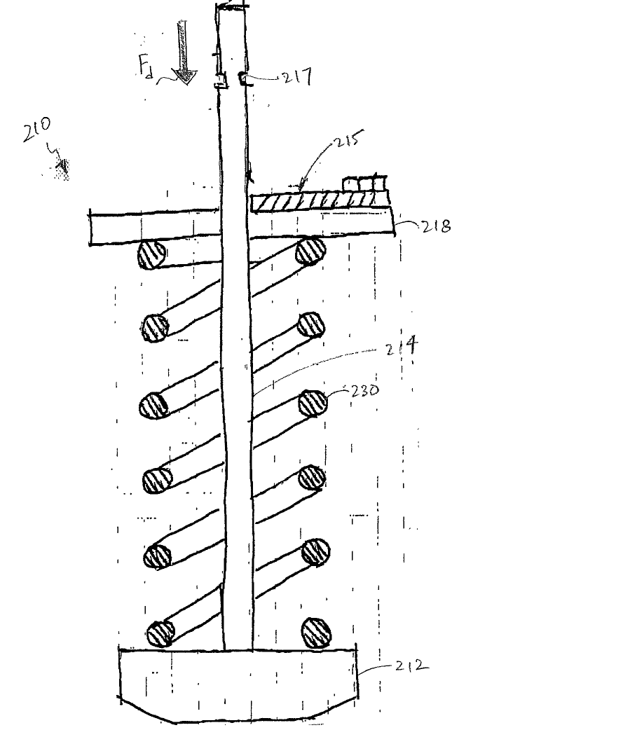

Referring now to FIGS. 5-8, another exemplary embodiment of a water drain valve is shown generally at 210 and is hereinafter referred to as “valve 210.” Valve 210 comprises a spring 230 fabricated of a non-shape memory metal disposed on a stem 214 axially translatable through an aperture in a support member 218. A disk 212 is disposed on an end of stem 214 and is engagable with a seat 213 disposed in an orifice that defines a fluid flow. A latch, shown generally at 215, fabricated from a shape memory metal trained to have two-way memory is positioned to be mechanically cooperable with stem 214 and provides for operable communication between disk 212 and seat 213. The seating of disk 212 in seat 213 effectively closes valve 210, thereby preventing fluid flow through valve 210.

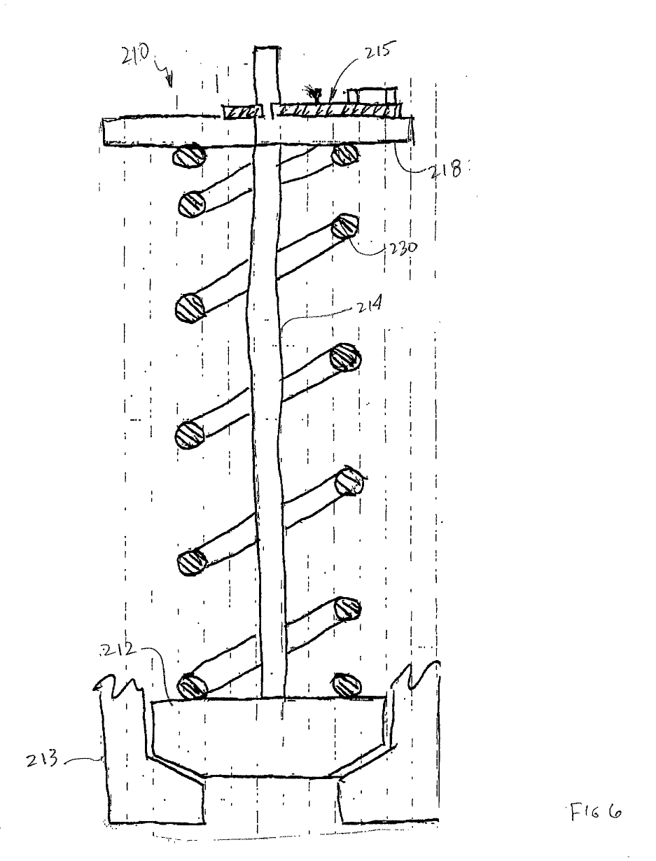

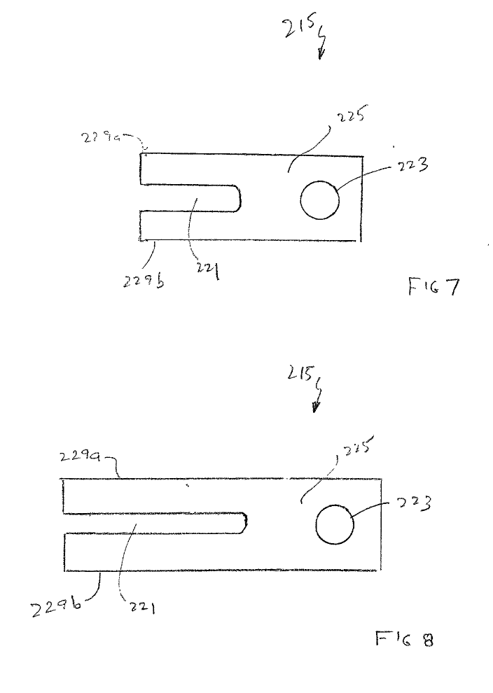

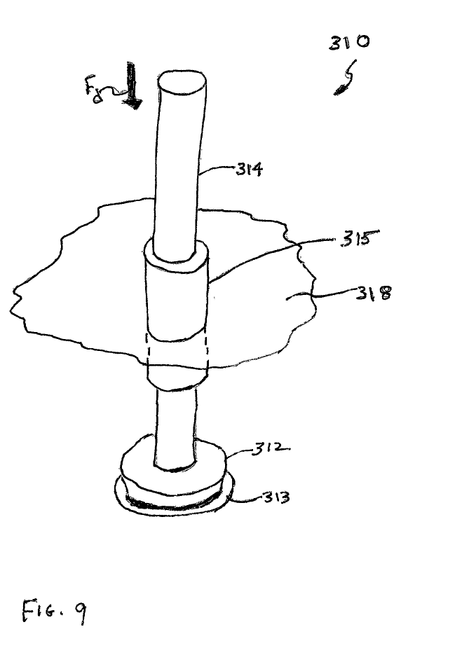

Referring specifically to FIG. 5, spring 230 is shown in an unstrained configuration. Stem 214 is mechanically translated in the axial direction either manually through operator intervention or automatically through a temperature controlled switching mechanism (not shown). Upon the cooling water of the cooling system of a locomotive engine having a temperature greater than about 40° F. and flowing into valve 210 and triggering latch 215, a force F_{d} is mechanically applied to stem 214 to seat disk 212. The application of force F_{d} to stem 214 causes spring 230 to extend in the longitudinal direction and seat disk 212 into seat 213, as is shown in FIG. 6. Latch 215 changes its shape such that a slot (shown below with reference to FIGS. 7 and 8) engages a notch 217 in stem 214. The slot is positioned on latch 215 such that the engagement of the slot with notch 217 causes stem 214 to be held in place with disk 212 seated in seat 213.

In FIGS. 7 and 8, latch 215 is shown in greater detail. Latch 215, as stated above, is fabricated of two-way shape memory metal and is mountable to the support member on a side opposing the side on which the spring is positioned. Latch 215 includes a body portion 225 and first and second members (shown as legs 229a, 229b) defining the slot 221. Slot 221 is configured and dimensioned to engage the notch disposed in the stem upon actuation of the metal of latch 215. A mounting hole 223 disposed in latch 215 provides for the mounting of latch 215 to the support member.

The shape memory metal of which latch 215 is fabricated is trained such that the phase transformation occurs at about 40° F. Below such a temperature, the shape memory metal causes latch 215 to be shortened, as is shown in FIG. 7. When latch 215 is shortened, the dimensions of slot 221 are such that the stem can easily pass therethrough, allowing for the valve to be in the open position. When, however, the temperature is above about 40° F., the metal of which latch 215 is fabricated transforms and causes legs 229a, 229b to change dimensions in both the lengthwise and widthwise directions. The mechanical application of the force that translates the stem through the aperture in the support member and seats the disk is coordinated with the exact temperature at which the phase transformation occurs and causes the dimensional changes of legs 229a, 229b. At that temperature, the mechanical application of the force causes the notch in the stem to align with slot 221 in latch 215, thereby allowing the spring to be maintained in its extended position to close the valve. Actuation of latch 215 causes a change in the dimensions of slot 221, thereby trapping the stem at the notch. When the locomotive engine is turned off and the cooling water in the cooling system drops below about 40° F., the metal of latch 215 “remembers” its shape of the previous phase and reverts to it. As the metal transforms back to its previous phase, slot 221 enlarges and releases the stem allowing it to slide through as a result of the strain on the spring being relieved.

Referring now to FIG. 9, another exemplary embodiment of a valve is shown generally at 310. Valve 310 comprises a latch 315. Latch 315, like latch 215 as described and shown with reference to FIGS. 5-8, is fabricated of two-way shape memory metal. Latch 315, however, is of a tubular geometry and is disposed concentrically about a stem 314 of valve 310 into which latch 315 is incorporated. Latch 315 is supported at an outer surface thereof by a support member 318 of valve 310 such that the actuation of latch 315 and the engagement of latch 315 with stem 314 is the result of an expansion and contraction of the tubular structure in a direction radial to the longitudinal axis defined by the tubular geometry.

Stem 314 and latch 315 are dimensioned such that upon the water of the cooling system being above about 40° F., a force F_{d} is applied to stem 314 to cause stem 314 to translate through latch 315, thereby causing a disk 312 disposed on an end of stem 314 to seat in a seat 313 and prevent water flow through valve 310. At such a temperature, latch 315 contracts in a direction radial to the longitudinal axis defined by the tubular geometry and engages stem 314 to lock stem 314 in place. Force F_{d} is then removed from stem 314. Upon a decrease in temperature of the cooling water such that the temperature drops below about 40° F., a spring return of stem 314 in a direction opposite the application of force F_{d} causes stem 314 to be biased away from the orifice of valve 310 and the shape memory metal of which latch 315 is fabricated expands in the radial direction, thereby allowing stem 314 to move therethrough to retract disk 312 from seat 313 of valve 310 and allowing the water to flow through the orifice and drain from the system.

While preferred embodiments have been shown and described, various modifications and substitutions may be made thereto without departing from the spirit and scope of the invention. Accordingly, it is to be understood that the present invention has been described by way of illustration and not limitation.

1. A drain valve for a cooling system of an engine, the drain valve comprising:
an orifice disposed in fluid communication with the cooling system of the engine;
a flow restricting element communicable with said orifice; and
an actuator mechanism disposed in mechanical communication with said flow restricting element, said actuator mechanism being fabricated of a shape memory metal.

2. The drain valve of claim 1 wherein the shape memory metal is configured to be a spring.

3. The drain valve of claim 1 wherein the shape memory metal is expandable and contractable in at least one dimension.

4. The drain valve of claim 1 wherein the shape memory metal is expandable or contractable in at least one dimension.

5. The drain valve of claim 1 further comprising a stem depending from said flow restricting element, said stem being slidably supported to facilitate the receiving of said flow restricting element in said orifice.

6. The drain valve of claim 1 wherein the shape memory metal is a nickel titanium alloy.

7. A valve for a locomotive engine coolant drain system, the valve comprising:
an orifice disposed in fluid communication with the locomotive engine cooling system;
a flow restricting element mechanically communicable with said orifice; and
a spring disposed in mechanical communication with said flow restricting element and supported at a support surface, said spring being fabricated from a shape memory metal.

8. The valve of claim 7 wherein said spring is configured to define a helically arranged coil.

9. The valve of claim 7 wherein the shape memory metal is expandable and contractable in at least one dimension.

10. The valve of claim 7 wherein the shape memory metal is expandable or contractable in at least one dimension.

11. The valve of claim 8 further comprising a stem depending from said flow restricting element and extending longitudinally through the helically arranged coil of said spring.

12. The valve of claim 11 further comprising a return spring disposed longitudinally around said stem, said return spring being in mechanical communication with said flow restricting element and supported at the support member.

13. The valve of claim 7 wherein the shape memory metal is a nickel titanium alloy.

14. An actuating mechanism for a valve of a locomotive engine cooling system, the actuating mechanism comprising:
an expandable element, said expandable element being fabricated from a shape memory metal, said expandable element further being supported at an end thereof, and said expandable element further being configured to provide directional translation to a flow restricting element attached at an opposing end thereof, said flow restricting element being receivable in a flow orifice disposed in fluid communication with the locomotive engine cooling system.

15. The actuating mechanism of claim 14 wherein said expandable element is configured as a helically arranged coil spring.

16. The actuating mechanism of claim 14 wherein the shape memory metal is expandable and contractable in at least one dimension.

17. The actuating mechanism of claim 14 wherein the shape memory metal is either expandable or contractable in at least one dimension.

18. The actuating mechanism of claim 14 wherein said expandable element is a latching mechanism configured to trap said flow restricting element and to either allow for or prevent flow through the flow orifice.

19. The actuating mechanism of claim 14 wherein the shape memory metal is a nickel titanium alloy.

20. A latch mechanism for a drain valve for a locomotive engine cooling system, the latch mechanism comprising:
a member configured to intermittently engage a stem of the drain valve to prevent or allow movement thereof, said member being fabricated of a shape memory metal.

21. The latch mechanism of claim 20 wherein the stem of the drain valve includes a notch disposed therein, the notch being configured and dimensioned to be intermittently engagable by said member.

22. The latch mechanism of claim 20 wherein said latch mechanism further includes a second member disposed proximate said member, said second member being configured to enhance the engagement of the stem of the drain valve by said member.

23. The latch mechanism of claim 22 wherein said second member includes a contoured surface dimensioned to correspond to and accommodate the stem upon the engagement of the stem with said contoured surface.

24. The latch mechanism of claim 22 wherein said second member is fabricated from a shape memory metal.

25. The latch mechanism of claim 20 wherein said member is of a tubular geometry and is concentrically disposed about a longitudinal axis of the stem of the drain valve.

26. The latch mechanism of claim 20 wherein said shape memory metal is a nickel titanium alloy.

27. A drain valve for a locomotive engine cooling system, the valve comprising:
an expandable spring;
a flow restricting element disposed in mechanical communication with said expandable spring and configured to provide intermittent flow from the locomotive engine cooling system;
a latch mechanism fabricated from a shape memory metal, said latch mechanism being disposed in mechanical communication with said flow restricting element; and
an orifice disposed in fluid communication with the locomotive engine cooling system, said orifice being dimensioned to receive said flow restricting element therein to provide regulation of a coolant flow through said orifice.

28. The drain valve of claim 27 further comprising a stem depending from said flow restricting element, said stem being translatable in an axial direction to seat said flow restricting element in said orifice.

29. The drain valve of claim 28 wherein the mechanical communication between said latch mechanism and said flow restricting element is effectuated through said stem.

30. The drain valve of claim 29 wherein said stem includes a notch disposed therein for receiving said latch mechanism.

31. The drain valve of claim 27 wherein said latch mechanism, comprises:
a body portion;
a first leg depending from said body portion; and
a second leg depending from said body portion, said second leg configured and dimensioned to be parallel to said first leg and to define a space between said first leg and said second leg.

32. The drain valve of claim 27 wherein the shape memory metal is a nickel titanium alloy.
